(19) United States
(12) Patent Application Publication
(10) Pub. No.: US 2010/0187903 A1
(43) Pub. Date: Jul. 29, 2010

(54) METHOD AND SYSTEM FOR VEHICULAR POWER DISTRIBUTION UTILIZING POWER OVER ETHERNET IN AN AIRCRAFT

(76) Inventors: Wael William Diab, San Francisco, CA (US); Michael Johas Teener, Santa Cruz, CA (US); Yongbum Kim, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/751,917

(22) Filed: Mar. 31, 2010

Related U.S. Application Data
(63) Continuation-in-part of application No. 12/196,142, filed on Aug. 21, 2008.
(60) Provisional application No. 61/014,349, filed on Dec. 17, 2007.

(51) Int. Cl. B60L 1/00

(52) U.S. Cl. 307/9.1

(57) ABSTRACT

Aspects of a method and system for vehicular power distribution utilizing power over Ethernet in an aircraft are provided. In this regard, one or more circuits and/or processors may be operable to receive supply power that is formatted in accordance with one or more aviation standards, condition the received supply power, and provide the conditioned supply power to one or more electronic components that are communicatively coupled to the Ethernet cable. The one or more circuits and/or processors may be built into and/or mounted on a seat in the aircraft. The one or more circuits and/or processors may provide the conditioned supply power to the one or more electronic components based on a power classification of the one or more electronic components.

### CROSS-REFERENCE TO RELATED APPLICATIONS/INCORPORATION BY REFERENCE

This patent application is a continuation-in-part of U.S. patent application Ser. No. 12/196,142 filed on Aug. 21, 2008 which claimed the benefit of U.S. Provisional Application Ser. No. 61/014,349 filed Dec. 17, 2007 and entitled “Method and System for Automotive Power Distribution Utilizing Power Over Ethernet.”

This application also makes reference to: U.S. patent application Ser. No. ______ (Attorney Docket No. 19275US03) filed on even date herewith;

U.S. patent application Ser. No. 11/686,867 filed on Mar. 15, 2007; and
U.S. patent application Ser. No. 11/686,852 filed on Mar. 15, 2007.

Each of the above stated applications is hereby incorporated herein by reference in its entirety.

The above stated provisional application is hereby incorporated herein by reference in its entirety.

### FIELD OF THE INVENTION

Certain embodiments of the invention relate to a method and system for vehicular electronics. More specifically, certain embodiments of the invention relate to a method and system for vehicular power distribution utilizing power over Ethernet in an aircraft.

### BACKGROUND OF THE INVENTION

From staying connected, to assisting with daily tasks, to providing entertainment, electronics are becoming an increasingly important aspect of people's daily lives. Accordingly, vehicles are increasingly being equipped with advanced electronics equipment. For example, advanced stereos and sound systems, navigation equipment, and back-up assist cameras, and an increasing number of diagnostic sensors are just some of the advanced electronics being installed in vehicles. Consequently, installation and interoperation of the various electronic devices is becoming increasingly complicated and expensive. In this regard, the wiring alone required for communicating data to and from the various electronic devices is a major source of cost and complication in a vehicle electronic network. In this regard, specialized physical media, as is conventionally utilized in the vehicular industry, may be expensive. Additionally, existing standards for vehicular networking, such as MOST and IDB-1394, are immature and largely unproven at high data rates. Additionally, non-standardized devices, connectors, and/or protocols utilized by vehicular electronics networks may further add to the cost and complexity. Thus, conventional and traditional vehicular electronics network may be expensive, complicated, and difficult to upgrade.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for vehicular power distribution utilizing power over Ethernet in an aircraft, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating delivery of data and supply power over a vehicular Ethernet connection, in accordance with an embodiment of the invention.

FIG. 2A is a diagram of a conventional vehicular electronics network where data and/or supply power are delivered separately, in connection with an embodiment of the invention.

FIG. 2B is a diagram illustrating delivery of supply power and data via Ethernet in a vehicular electronics network, in accordance with an embodiment of the invention.

FIG. 2C is a diagram illustrating a vehicle electronics network comprising a networking device for delivering supply power and data over Ethernet, in accordance with an embodiment of the invention.

FIG. 2D is a diagram illustrating delivery of supply power and data via Ethernet in a vehicular electronics network comprising daisy-chained devices, in accordance with an embodiment of the invention.

FIG. 3A is a diagram illustrating an exemplary vehicular electronics network, in accordance with an embodiment of the invention.

FIG. 3B is a diagram illustrating another exemplary vehicular electronics network, in accordance with an embodiment of the invention.

FIG. 3C is a diagram illustrating an exemplary vehicular electronics network comprising a plurality of devices coupled in a daisy chain topology.

FIG. 4 is a diagram illustrating distribution of supply power in a vehicular electronics network, in accordance with an embodiment of the invention.

FIG. 5 is a flow chart illustrating powering one or more devices of a vehicular electronics network via one or more Ethernet cables, in accordance with an embodiment of the invention.

FIG. 6 is a diagram illustrating power distribution utilizing power over Ethernet (PoE) in an aircraft, in accordance with an embodiment of the invention.

### DETAILED DESCRIPTION OF THE INVENTION

Certain embodiments of the invention may be found in a method and system for a centralized vehicular electronics network utilizing Ethernet in an aircraft. In various embodiments of the invention, one or more circuits and/or processors may be operable to receive supply power that is formatted in accordance with one or more aviation standards, condition the received supply power, and provide the conditioned supply power to one or more electronic components that are communicatively coupled to the Ethernet cable. The electronic components may comprise one or more of a display, an Ethernet port, an audio input port, an audio output port, a video input port, a video output port, a power port, an input device, and a motor. The circuits and/or processors may be operable to perform bridging, switching, and/or routing functions. The one or more circuits and/or processors may be built into and/or mounted on the one or more seats in the aircraft. The conditioned supply power may be delivered in adherence with power over Ethernet standards. The one or more circuits and/or processors may provide the conditioned supply power to the one or more electronic components based on a power classification of the one or more electronic components. The power classification may be determined utilizing layer 2 and/or 2-event classification. The one or more circuits and/or processors may comprise a plurality of Ethernet ports such that seats in the aircraft may be connected in a daisy-chain configuration or topology. The one or more circuits and/or processors may be operable to extract media from Ethernet packets received over the Ethernet cable and convey the media to one or more of the electronic components. The one or more circuits and/or processors may be operable to format the media prior to conveyance to the one or more of the electronic components. The Ethernet cable may comprise one or more twisted pairs. The conditioning may comprise one or more of: adjusting a frequency of the received supply power, adjusting voltage levels of the received supply power, alternating current to direct current (AC to DC) conversion, and direct current to alternating current (DC to AC) conversion.

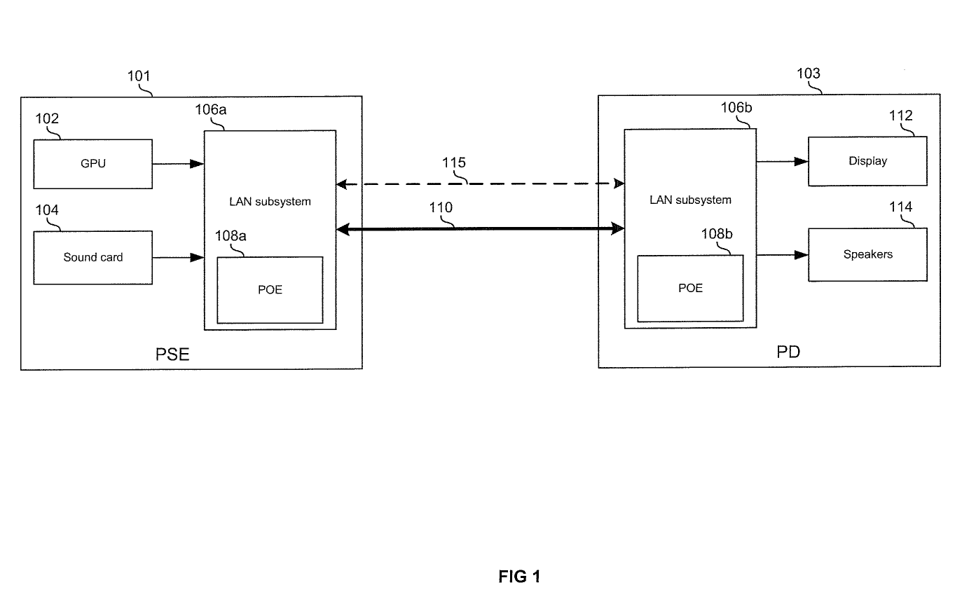

FIG. 1 is a diagram illustrating delivery of data and/or supply power over an Ethernet connection, in accordance with an embodiment of the invention. Referring to FIG. 1 there is shown power supplying equipment (PSE) 101, a network cable 110, a redundant network cable 115, and powered device (PD) 103. In the exemplary embodiment of the invention depicted in FIG. 1, the PSE 101 and PD 103 may be non-mission critical electronic devices. In various other embodiments of the invention, the equipment may comprise a mission critical vehicular electronic device such as a central computing system or any of a variety of diagnostic sensors or monitors. In this regard, rather than exchanging, for example, multimedia or navigation information, mission critical devices of a vehicular electronics network may exchange, for example, diagnostic and or sensor information. Guaranteed quality of service made possible utilizing AVB may enable combining mission critical and non-mission critical devices into a single vehicular network rather than having separate networks for mission critical and non-mission critical devices. Additionally, aspects of the invention may enable providing power over Ethernet links to mission-critical devices first and providing remaining or excess supply power to non-mission critical devices. Similarly, a certain amount of available supply power may be available only to mission critical devices.

The cable 110 may be a physical medium suitable for conveying data and supply power. In various embodiments of the invention, the cable 110 may comprise Cat-5 (or similar) cabling comprising one or more twisted pair physical channels. In this regard, the cable 110 may be a conventional Cat-5 cable comprising four twisted pairs with an 8 position 8 conductor (8P8C) plug (often referred to as RJ-45) on either end. In other embodiments of the invention, the cable 110 may comprise physical media which may not be utilized in a conventional Ethernet network but may be suitable and/or desirable for a vehicular electronic network. In this regard, Ethernet cables and/or the connectors with which they are terminated and/or to which they are coupled, may be modified, enhanced, or otherwise different from their conventional counterparts utilized in conventional Ethernet networks. For example, shielded and/or unshielded cable may be utilized, cables may be terminated in ganged connectors, and cables may comprise any number of twisted pairs. In this regard, the link may comprise a cable with fewer than 4 twisted pairs to reduce cost and/or weight. In this regard, the PSE 101 and the PD 103 may be operable to supply and/or receive supply power via an Ethernet link comprising a single physical channel as disclosed in United States Provisional Patent Application No. 61/082,541, filed on Jul. 22, 2008 which is hereby incorporated herein by reference in its entirety.

In various embodiments of the invention, one or more redundant network cables, such as the cable 115 depicted as a dashed line in FIG. 1, may additionally couple the PSE 101 and the PD 103. In various embodiments of the invention, loops in the network may be normally blocked as a result of a spanning tree algorithm but may be utilized in the event of a network failure. Alternatively, redundant paths may be utilized to increase throughput between two or more devices in a network.

The PSE 101 may comprise a graphics processing unit (GPU) 102, a sound card 104, and a local area networking (LAN) subsystem 106a. The PSE 101 may be enabled to transmit data, including but not limited to high definition multimedia streams, over the network cable(s) 110 and/or 115 and/or provide supply power to the PD 103 over the cable(s) 110 and/or 115. The GPU 102 may comprise suitable logic, circuitry, interfaces, and/or code that may enable generating graphics and/or video data. In this regard, resolution, encoding, format, compression, data rates, and/or other characteristics of video and/or graphics out of the GPU 102 may vary without deviating from the scope of the invention. For example, high definition video of 720p, 1080i, 1080p, or even higher resolution may be supported and output by the GPU 102. The sound card 104 may comprise suitable logic, circuitry, interfaces, and/or code that may enable generating audio data. In this regard, resolution, encoding, format, compression, data rates, and/or other characteristics of an audio stream out of the sound card 104 may vary without deviating from the scope of the invention. For example, audio sample at 44.1 kHz, 96 kHz, 192 kHz or even higher may be supported and output by the sound card 104.

The PD 103 may comprise a LAN subsystem 106b, a display 112, and one or more speakers 114. The PD 103 may be enabled to receive data, including but not limited to high definition multimedia streams, via the network cable(s) 110 and/or 115 and/or be powered by a supply voltage and/or current received via the cable(s) 110 and/or 115. The display 112 may be enabled to present video and/or graphics to a user. In various embodiments of the invention, data passed to the display 112 from the LAN subsystem 106b may be raw graphics and/or video or may be formatted according to one or more standards such as HDMI or DisplayPort. The speaker(s) 114 may be enabled to present audio to a user. In various embodiments of the invention, data passed to the speaker(s) 114 from the LAN subsystem 106b may be raw audio or may be formatted according to one or more standards such as Mp3 or AAC.

The LAN subsystems 106a and 106b may each comprise suitable logic, circuitry, interfaces, and/or code that may enable transmitting and/or receiving data over a network. The LAN subsystems 106a and 106b may each be enabled to utilize AVB. The LAN subsystems 106a and 106b may each utilize Ethernet protocols for transmitting and/or receiving data via the network cable(s) 110 and/or 115. In this regard, the LAN subsystems 106a and 106b may each comprise a medium access control (MAC) module and a PHY. In various embodiments of the invention, the LAN subsystems 106a and 106b may each support a variety of data rates such as 10 Mbps, 100 Mbps, 1000 Mbps (or 1 Gbps), 2.5 Gbps, 4 Gbps, 10 Gbps, or 40 Gbps, for example. In this regard, the LAN subsystems 106a and 106b may each support standard-based data rates and/or non-standard data rates. Additionally, the LAN subsystems 106a and 106b may each be enabled to format, encode, packetize, compress, decompress, encrypt, decrypt, or otherwise process multimedia data. The LAN subsystems 106a and 106b may comprise power over Ethernet (PoE) blocks 108a and 108b, respectively. Additionally, the LAN subsystems 106a and 106b may each be operable to perform a diagnostic of the cable 110. In this manner, network problems such as open-circuited and short-circuited links, e.g., from a failed connector or severed wire, may be detected and the quality of an Ethernet link may be determined.

One or more of the LAN subsystems 106a and 106b may comprise a twisted pair PHY capable of operating at one or more standard rates such as 10 Mbps, 100 Mbps, 1 Gbps, and 10 Gbps (10BASE-T, 100 GBASE-TX, 1 GBASE-T, and/or 10 GBASE-T); potentially standardized rates such as 40 Gbps and 100 Gbps; and/or non-standard rates such as 2.5 Gbps and 5 Gbps. The LAN subsystems 106a and 106b may support multi-lane topologies such as 40 Gbps CR4, ER4, KR4; 100 Gbps CR10, SR10 and/or 10 Gbps LX4 and CX4. Also, serial electrical and copper single channel technologies such as KX, KR, SR, LR, LRM, SX, LX, CX, BX10, LX10 may be supported. Non-standard speeds and non-standard technologies, for example, single channel, two channel or four channels may also be supported.

Each of the cables 110 and 115 may comprise, for example, shielded copper cabling, plain old telephone (pots) cabling, category 3, 5, 5e, 6, 6a, 7, 7a cabling, or any other suitable cabling for delivering data and/or power.

The PoE block 108a may comprise suitable logic, circuitry, interfaces, and/or code that may enable providing supply power to the PD 103 via the cable(s) 110 and/or 115 and for controlling an amount of supply power provided to the PD 103 via the cable(s) 110 and/or 115. In some embodiments of the invention, the PoE 108a may adhere to power over Ethernet standards IEEE 802.3af and/or IEEE 802.3 at. In some embodiments of the invention, native vehicle power may be distributed over one or more Ethernet cables. In this regard, in some embodiments of the invention, power may not be as established in IEEE 802.3 standards. For example, American passenger vehicles typically have a native 12 Vdc power system generated by one or more batteries and/or alternators. Accordingly, one or more of the Ethernet cables 110 and/or 115 may distribute the 12 Vdc to one or more devices of the vehicle. Similarly, aircraft may have 400 Hz Vac and/or 28 Vdc power systems that may be distributed via the POE block 108a. The PoE block 108a may be enabled to manage a voltage and/or current supplied to the PD 103 in order to improve energy efficiency. In this regard, the PoE block 108a may receive one or more control signals from other devices of the LAN subsystem 106a. In various embodiments of the invention, the PoE blocks 108a and 18b may be compatible with legacy PoE systems and/or may be enhanced and/or modified to meet needs and/or desires of a vehicular automotive network.

The PoE block 108b may comprise suitable logic, circuitry, interfaces, and/or code for receiving supply power via the cable(s) 110 and/or 115. In various embodiments of the invention, the PoE 108a may adhere to power over Ethernet standards IEEE 802.3af and/or IEEE 802.3 at. In this regard, the POE block 108b may be enabled to receive supply power via the cable(s) 110 and/or 115 and distribute, regulate, or otherwise manage the received supply power. In this manner, at least a portion of the LAN subsystem 106b, the display 112, and/or the speaker(s) 114 may operate using supply power received via the cable(s) 110 and/or 115. In various embodiments of the invention, the PoE block 108b may be enabled to indicate a supply power required from the PSE 101. For example, the PoE block 108b may comprise a variable sense resistor. In this regard, the PoE block 108a may receive one or more control signals from other devices of the LAN subsystem 106b.

In operation, the GPU 102 may generate video and/or graphics and may transfer the video or graphics to the LAN subsystem 106a for additional processing and/or formatting according to one or more networking standards. In one embodiment of the invention, the GPU 102 may output raw video/graphics to the LAN subsystem 106a. In another embodiment of the invention, the GPU 102 may output formatted video and/or graphics, DisplayPort or HDMI, for example, to the LAN subsystem 106a. The LAN subsystem 106a may encapsulate multimedia data into Ethernet frames and transmit the frames onto the cable(s) 110 and/or 115. The LAN subsystem 106b may receive multimedia data over the network cable(s) 110 and/or 115. The LAN subsystem 106b may de-packetize, parse, format, and/or otherwise process the received data and may convey received video data to the display 112 and may convey received audio data to the speaker(s) 114.

In some embodiments of the invention, the POE block 108a may be enabled to determine a power class of the PD 103 based on a sense resistance in the POE block 108b. For example, passengers in an aircraft may utilize a variety of networking devices which may have varying supply power demands. Accordingly, aspects of the invention may enable dynamically altering the sense resistance in the PoE block 108b to improve energy efficiency. In other embodiments of the invention, the POE block 108a may utilize power classification techniques similar to or the same as those being developed by the IEEE 802.3 at task force. In this regard, 2-Event classification and/or Layer 2 Classification may be supported by the POE blocks 108a and/or 108b.

In this manner, a power class may be determined based on the type of PD communicatively coupled to the cable(s) 110 and/or 115. For example, a smart phone may require less supply power than a laptop. Additionally, the power class may be dynamically configured for a given PD 103. For example, a lower power class may be selected by a display when the display is processing and/or presenting low resolution video, whereas a higher power class may be selected when the display is processing high definition.

In various embodiments of the invention, data communicated over the link 110 may be secured utilizing one or more protocols such as and/or IEEE 802.1ae (MACSec) and/or related protocols such as IEEE 802.1af and IEEE 802.1ar. In this regard, security protocols may be of particular importance for mission-critical devices.

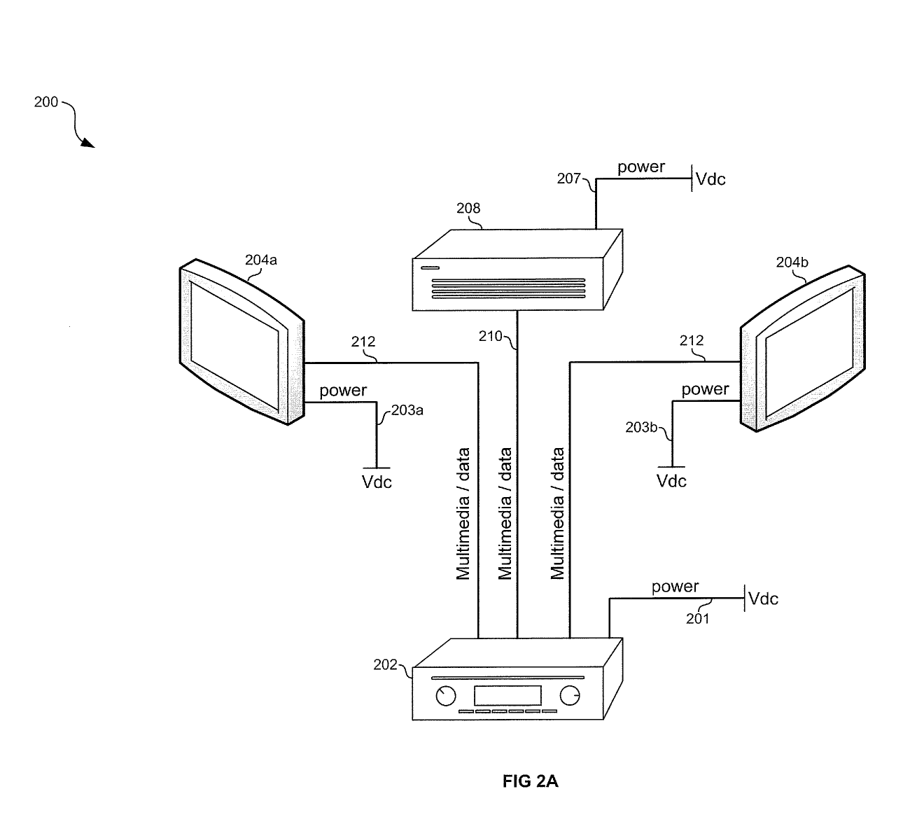

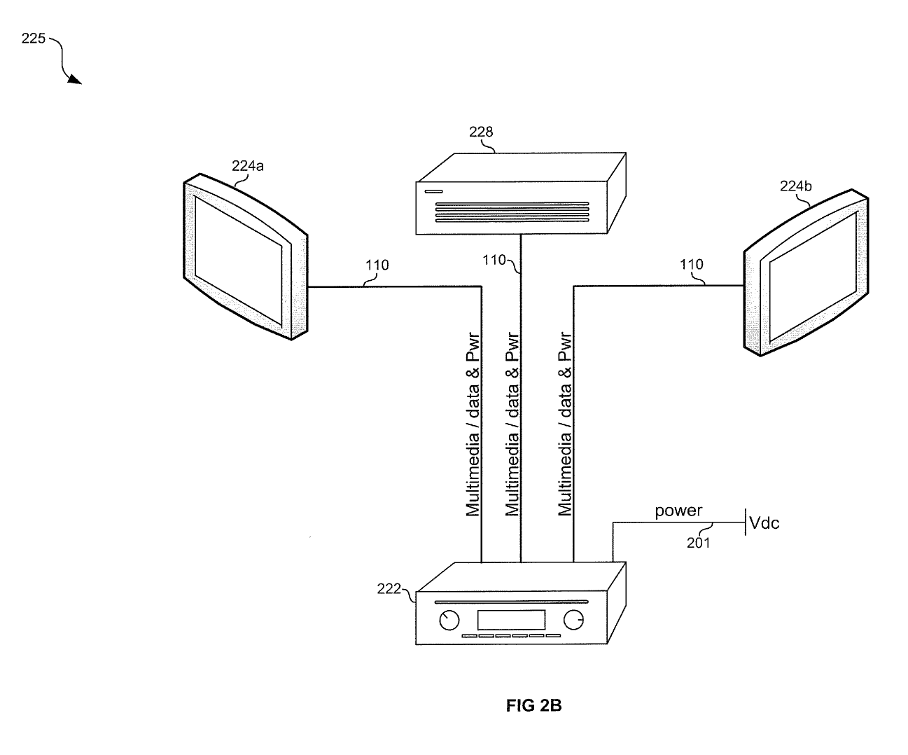

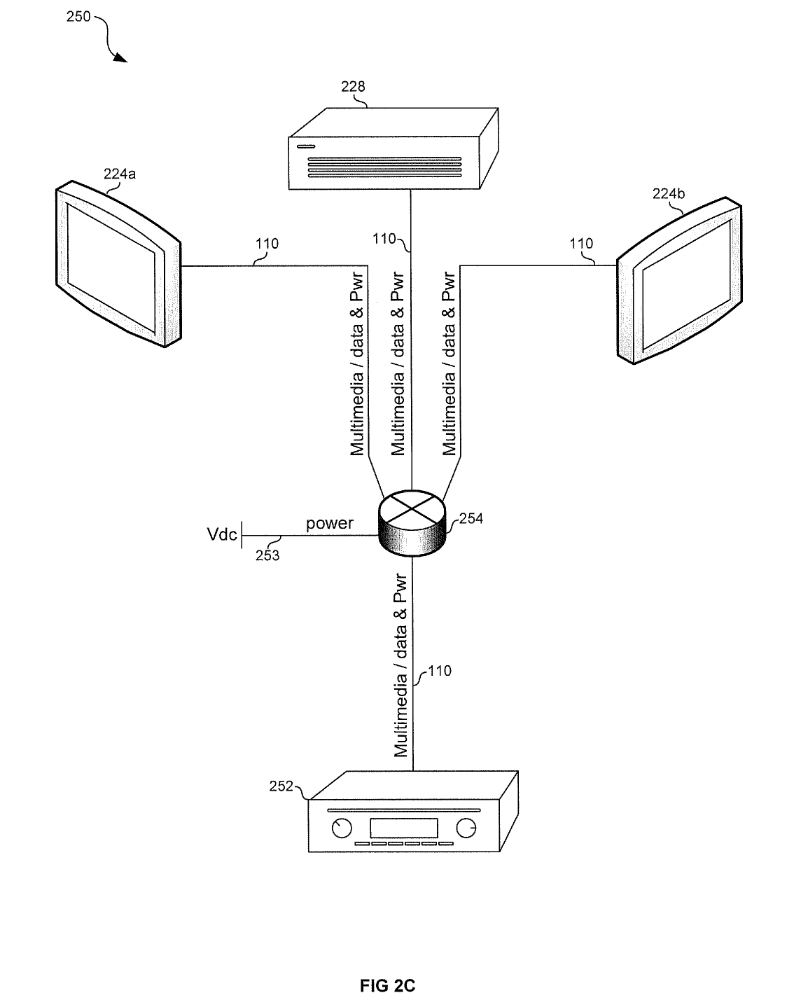

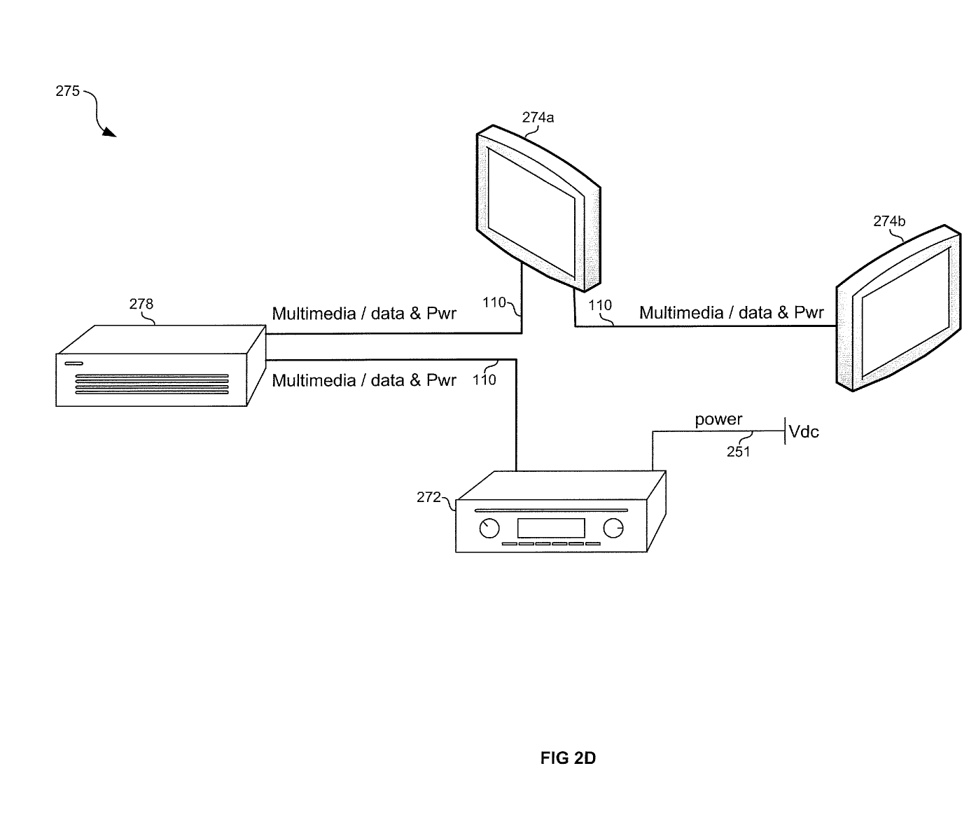

FIG. 2A is a diagram of a conventional vehicular electronics network where data and/or supply power are delivered separately, in connection with an embodiment of the invention. Referring to FIG. 2A the conventional vehicular electronics network 200 may comprise entertainment and/or navigation equipment 202, displays 204, and computing and/or entertainment device 208. The entertainment and/or navigation equipment 202 may be communicatively coupled to the displays 204 via links 212 and to the computing and/or entertainment device 208 via the link 210. In this regard, communicatively coupling different types of vehicular electronic devices may require different cables and/or connectors. Additionally, each of the devices of the vehicular electronics network 200 may be powered via power connections 201, 203a, 203b, and 207, respectively.

The entertainment and/or navigation equipment 202 may comprise suitable logic, circuitry, interfaces, and/or code that may enable delivering and/or receiving data to/from the various other devices of the vehicular electronics network 200. In this regard, entertainment and/or navigation equipment 202 may, for example, operate as a user interface and/or central processing unit for controlling entertainment, navigation, and/or other electronic devices of the vehicular electronics network 200. Different entertainment and/or navigation equipment 202 may comprise different and/or proprietary connectors and/or interfaces which may increase the complexity and/or cost of installing the equipment 202 into new or existing vehicular electronics networks. Similarly, different and/or proprietary connectors and/or interfaces on the equipment 202 may limit compatibility of the equipment 202 with other vehicular electronic devices.

The displays 204 may comprise suitable logic, circuitry, interfaces, and/or code that may enable, for example, rendering and/or presenting audio and/or video received from the entertainment and/or navigation equipment 202. Additionally, in some instances, the displays 204 may comprise, for example, a touch screen and may enable controlling and/or providing input to the entertainment and/or navigation equipment 202. Different displays 204 may comprise different and/or proprietary connectors and/or interfaces which may increase the complexity and/or cost of installing the displays 204 into new or existing vehicular electronics networks. Similarly, different and/or proprietary connectors and/or interfaces on the displays 204 may limit compatibility of the displays 204 with other vehicular electronic devices.

The computing and/or entertainment device 208 may comprise suitable logic, circuitry, interfaces, and/or code that may enable processing electronic information. In this regard, the computing and/or entertainment device 208 may represent a variety of miscellaneous electronic equipment which may be found in a vehicular electronics network. For example, the computing and/or entertainment device 208 may comprise an optical drive, a hard-drive, solid-state storage, one or more sensors, audio equipment, etc. Different computing and/or entertainment devices 208 may comprise different and/or proprietary connectors and/or interfaces which may increase the complexity and/or cost of installing the computing and/or entertainment devices 208 into new or existing vehicular electronics networks. Similarly, different and/or proprietary connectors and/or interfaces on the computing and/or entertainment device 208 may limit compatibility of the computing and/or entertainment device 208 with other vehicular electronic devices.

In operation, each of the devices of the vehicular electronics network 200 may be powered via a dedicated and possibly different power connector and/or interface. In this regard, each component of the vehicular electronics network 200 may require a pair of wires connected to, for example, a 12Vdc vehicular power source. Accordingly, power cables 201, 203a, 203b, and 207 may result in a large and/or complicated wiring scheme. Moreover, because a conventional vehicle may comprise only a 12Vdc power source, each component of the vehicular electronics network 200 may comprise power conditioning circuitry to adapt the 12Vdc to meet that component's power needs. This need for each component of the vehicular electronics network 200 to regulate its own power supply may lead to increased cost and/or complexity of each of the devices 202, 204a, 204b, and 208.

FIG. 2B is a diagram illustrating delivery of supply power and data via Ethernet in a vehicular electronics network, in accordance with an embodiment of the invention. Referring to FIG. 2B, the vehicular electronics network 225 may comprise entertainment and/or navigation equipment 222, displays 224, and computing and/or entertainment device 228. Various embodiments of the invention may comprise additional, different, and/or fewer electronic devices without deviating from the scope of the invention.

The entertainment and/or navigation equipment 222 may differ from the conventional entertainment and/or navigation equipment 202 described with respect to FIG. 2A in that the entertainment and/or navigation equipment 222 may be enabled to provide supply power to devices to which it is communicatively coupled. In this regard, the entertainment and/or navigation equipment 222 may provide supply power to and exchange data, including but not limited to HD multimedia streams, with each of a variety of automotive electronics devices via one or more Ethernet cables 110 and/or possibly one or more redundant cables 115 (not shown). In this regard, the entertainment and/or navigation equipment 222 may be power supplying equipment (PSE) and may condition voltage and/or currents received via the connection 201 prior to distributing supply power over the cables 110. The entertainment and/or navigation equipment 222 may deliver supply power over the cables 110 utilizing power over Ethernet (PoE) standards. The entertainment and/or navigation equipment 222 may also differ from the conventional entertainment and/or navigation equipment 202 described with respect to FIG. 2A in that it may be enabled to communicate in accordance with Ethernet standards and may additionally utilize Audio Video Bridging and/or extensions thereto (collectively referred to herein as AVB) for transmission and/or reception of multimedia and/or time sensitive data. Thus, data and supply power may be conveyed over each of the cables 110. In various embodiments of the invention, the entertainment and/or navigation equipment 222 may comprise a server installed in an aircraft which may serve multimedia content to passengers, and/or may comprise an access point that may provide internet connectivity to passengers in an aircraft.

The displays 224 may differ from the displays 204 described with respect to FIG. 2A in that the displays 224 may receive supply power and exchange data via cables 110. In this regard, the displays 224 may each be a powered device (PD) similar to or the same as the PD 103 described with respect to FIG. 1. The displays 224 may be enabled to communicate in accordance with Ethernet standards and may additionally utilize Audio Video Bridging and/or extensions thereto (collectively referred to herein as AVB) for transmission and/or reception of multimedia and/or time sensitive data.

The computing and/or entertainment device 228 may differ from the conventional computing and/or entertainment device 208 described with respect to FIG. 2A in that the computing and/or entertainment device 228 may receive supply power and exchange data via a cable 110. In this regard, the computing and/or entertainment device 228 may be a powered device (PD) similar to or the same as the PD 103 described with respect to FIG. 1. The computing and/or entertainment device 228 may be enabled to communicate in accordance with Ethernet standards and may additionally utilize Audio Video Bridging and/or extensions thereto (collectively referred to herein as AVB) for transmission and/or reception of multimedia and/or time sensitive data. Additionally and/or alternatively, the computing device 228 may be operable to collect information from one or more sensors and communicate that information over an Ethernet cable 110. In this regard, data or information from sensors may be displayed visually or aurally to a driver or passenger via the network 225. Additionally, data collected by the computing device 228 may be utilized to control various portions of the vehicular electronics network 225 and/or various functions of the vehicle.

In operation, the entertainment and/or navigation equipment 222 may apply a DC voltage and/or current to one or more twisted pairs of each of the cables 110. In this manner, the equipment 222 may provide supply power to the displays 224 and/or the equipment 228. In various embodiments of the invention, the entertainment and/or navigation equipment 222 may be enabled to classify power requirements of each of the displays 224 and/or the computing and/or entertainment device 228 and provide corresponding supply power to the various devices. For example, each of the displays 224 and the computing and/or entertainment device 228 may comprise a sense resistance which may indicate a power class.

FIG. 2C is a diagram illustrating a vehicle electronics network comprising a networking device for delivering supply power and data over Ethernet, in accordance with an embodiment of the invention. Referring to FIG. 2C, there is shown a vehicular electronics network 250 similar to the vehicular electronics network 250 of FIG. 2B, but additionally comprising a networking device 254 coupled to a supply power source via a power cable 253. Various embodiments of the invention may comprise additional, different, and/or fewer electronic devices without deviating from the scope of the invention.

The entertainment and/or navigation equipment 252 may differ from the entertainment and/or navigation equipment 222 described with respect to FIG. 2B in that the entertainment and/or navigation equipment 252 may be powered device similar to the PD 103 of FIG. 1.

The networking device 254 may comprise suitable logic, circuitry, interfaces, and/or code for distributing supply power utilizing PoE. In this regard, the networking device 254 may receive supply power via the connection 253 from, for example, a 12Vdc vehicle power source. The networking device 254 may regulate or otherwise condition the supply power for distribution to various other devices of the vehicular electronics network 250. In this manner, the networking device 254 may operate as a supply power hub that may enable powering various devices in a vehicle via an inexpensive, standardized, and ubiquitous Ethernet connection. Additionally, the networking device 254 and may provide additional power ports for updating and/or reconfiguring the vehicular electronics network 250. Thus, the networking device 254 may simplify the installation and wiring of the vehicular electronics network 250. The networking device 254 may also comprise suitable logic, circuitry, interfaces, and/or code that may enable communicating data in accordance with Ethernet standards and may additionally utilize Audio Video Bridging (AVB) and/or AVB extensions (collectively referred to herein as AVB or Audio Video Bridging) for the communication of data, including but not limited to high definition multimedia streams and/or time sensitive data. In this manner, the networking device 254 may operate as a network switch, bridge, router, etc. for data communications in the vehicular electronics network 250. In various embodiments of the invention, the networking device 254 may be operable to perform higher layer (e.g., layer 3 and/or layer for of the OSI model) functions or protocols which may utilize, or run on top of, layer 2 Audio Video Bridging protocols. In various embodiments of the invention, the networking device 254 may be a midspan which may inject supply power onto one or more conductors of one or more cables 110 without affecting the data. In various embodiments of the invention, the networking device 254 may be an endspan that may, for example, process and/or operate on data in addition to injecting supply power onto one or more conductors of one or more cables 110.

In operation, the networking device 254 may classify the supply power needs of the entertainment and/or navigation equipment 222, the displays 224, and the entertainment and/or computing device 228, and may deliver a corresponding supply power to each of the devices. With regard to the entertainment and/or navigation equipment 222, supply power needs may, for example, depend on whether none, one, or both of navigation and entertainment functions are being utilized. With regard to the displays 224, supply power needs may depend on the source and type of video being displayed. With regard to the entertainment and/or computing device 228, supply power needs may depend on a type, amount, and/or rate of information being processed and/or generated. For power classification, each of the equipment 222, the displays 224, and the entertainment and/or computing device 228 may comprise, for example, a sense resistance that may be detected by the networking device 254. Additionally, and/or alternatively, supply power allocated to various device of the network 250 may depend on whether or not a device performs mission-critical functions. In various embodiments of the invention, the networking device 254 may regulate and/or condition the supply power distributed to each of the devices of the vehicular electronics network 250 and thus the entertainment and/or navigation equipment 222, the displays 224, and the entertainment and/or computing device 228 may not need additional supply power conditioning circuitry. In this manner, the networking device 254 may perform most or all of the supply power conditioning for the vehicular electronics network 250 and may thus reduce cost and/or complexity of the other devices of the vehicular electronics network 250.

Additionally, the networking device 254 may route data, encapsulated in Ethernet packets, between the various devices of the vehicular electronics network 250. In various embodiments of the invention, AVB may be utilized to ensure quality of service for the communicated data. Furthermore, connecting and disconnecting equipment to the vehicular electronics network 250 may be, for example, “plug and play” similar to or the same as a computer connecting to a conventional local area network. In this regard, an occupant of the vehicle may connect a portable or external electronic device to the vehicular electronics network 250. For example, an occupant of the vehicle may connect a laptop comprising a standard Ethernet port to the vehicular electronics network 250. In this manner, the laptop may be charged utilizing supply power received from the vehicular electronics network and/or data may be exchanged between the laptop and the vehicular electronics network.

FIG. 2D is a diagram illustrating delivery of supply power and data via Ethernet in a vehicular electronics network comprising daisy-chained devices, in accordance with an embodiment of the invention. Referring to FIG. 2D, there is shown a vehicular electronics network 275 similar to the vehicular electronics network 225 of FIG. 2B, but rather than the star topology of network 225, the devices of the network 275 may be communicatively coupled in a daisy-chain topology. The vehicular electronics network 275 may comprise entertainment and/or navigation equipment 272, computing and/or entertainment equipment 278, and displays 274. Various embodiments of the invention may comprise additional, different, and/or fewer electronic devices without deviating from the scope of the invention. Additionally, one or more redundant links for providing fail over operation or for increasing throughput, similar to the link 115 of FIG. 1, may be present in a vehicular electronics network utilizing any combination of star-coupled and daisy-chained devices.

The various devices of the network 275 may be similar to the devices of the network 225 but each device may comprise one or more additional network ports and associated circuitry, logic, and/or code. Accordingly, one or more of the devices of the network 275 may be operable to forward packets and route supply power between its two or more ports. In this manner, data exchanged between, for example, the entertainment and/or navigation equipment 272 and the displays 274 may be routed via the computing and/or entertainment device 278. Similarly, supply power delivered from the entertainment and/or navigation equipment 272 may pass through the computing and/or entertainment device 278 en route to the displays 274.

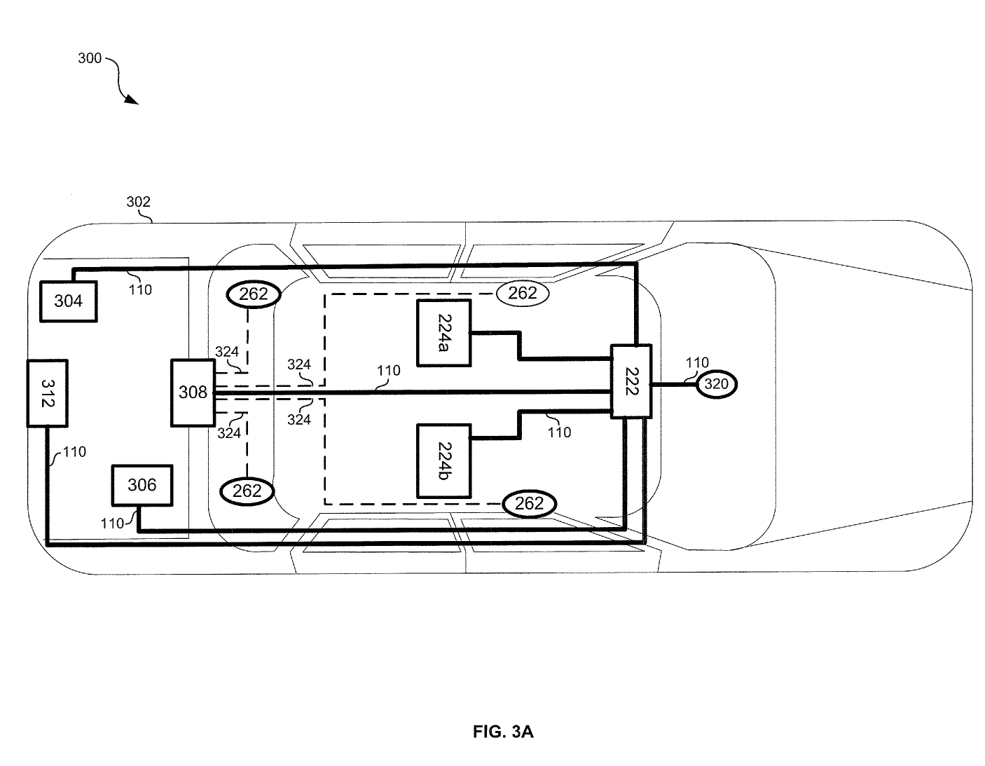

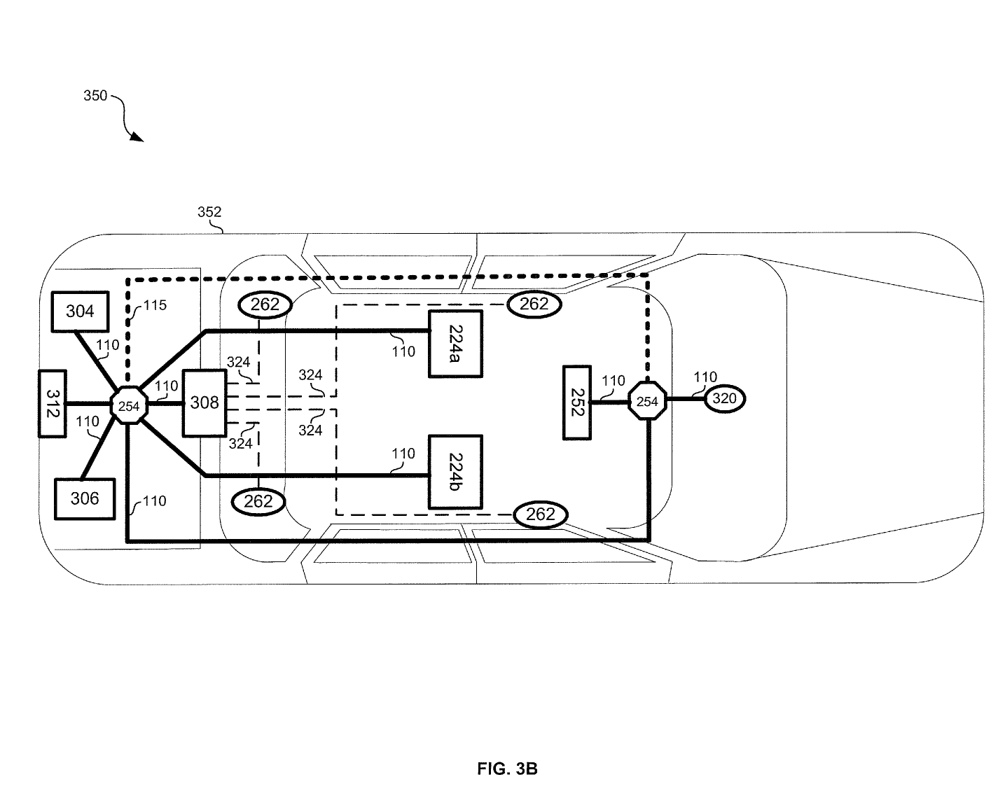

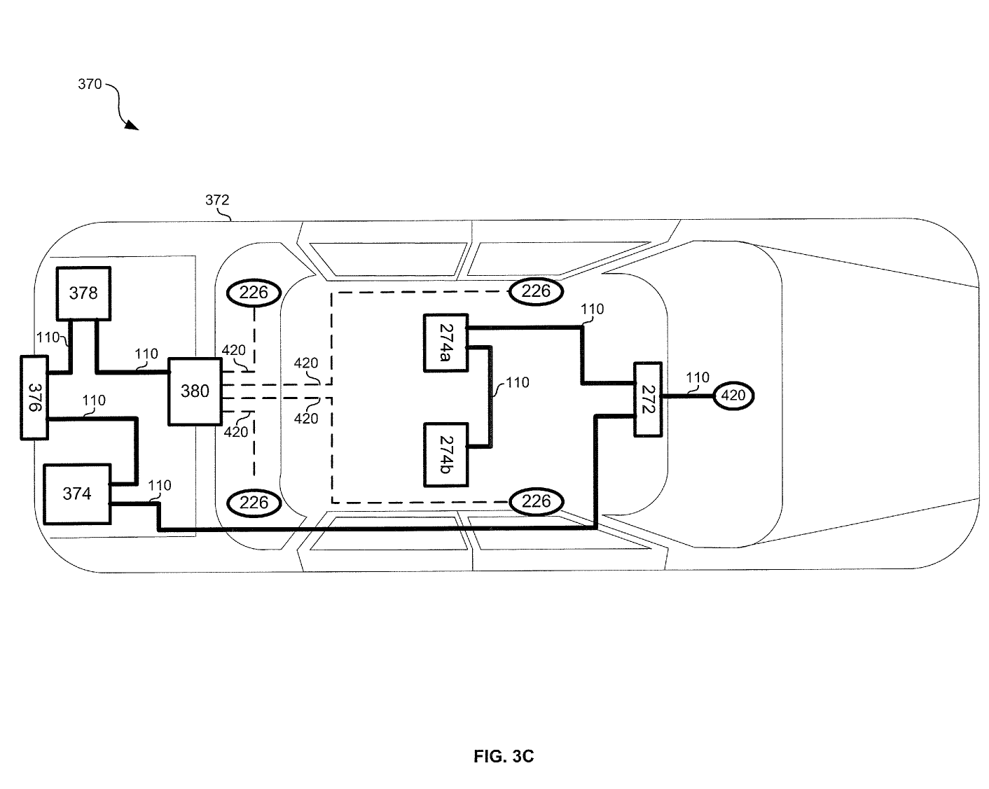

FIG. 3A is a diagram illustrating an exemplary vehicular electronics network, in accordance with an embodiment of the invention. Referring to FIG. 3A, the vehicle 302 may comprise a vehicular electronics network 300 similar to the vehicular electronics network 225 described with respect to FIG. 2B. In this regard, the embodiment depicted in FIG. 3A may depict an exemplary vehicular electronics network 300 communicatively coupled in a star topology via Ethernet cables 110. The vehicular electronics network 300 may comprise entertainment and/or NAV equipment 222, displays 224, speakers 262, entertainment equipment 304, computing device 306, and back-up assist camera 312. Various other embodiments of the invention may comprise additional, different, and/or fewer electronic devices without deviating from the scope of the invention.

The entertainment and/or navigation equipment 222 and the displays 224 may be as described with respect to FIG. 2B.

The computing device 306 may be similar to or the same as the computing and/or entertainment equipment 228 described with respect to FIG. 2B. In various embodiments of the invention, the computing device 306 may comprise suitable logic, circuitry, interfaces, and/or code for collecting information from one or more sensors and communicating that information over an Ethernet cable 110. In this regard, data or information from sensors may be displayed visually or aurally to a driver or passenger via the network 300. Additionally, data collected by the computing device 306 may be utilized to control various portions of the vehicular electronics network 300 and/or various functions of the vehicle.

The speakers 262 may comprise suitable logic, circuitry, interfaces, and/or code for converting audio data to acoustic waves. In some embodiments of the invention, analog audio signal may be conveyed to the speakers 262 via conventional speaker wire or via twisted pairs in a Cat-5 (or similar) cable. In some embodiments of the invention, audio data encapsulated in one or more Ethernet frames may be conveyed to the speakers 262 and the speakers 262 may be operable to convert the digital audio data to analog audio before converting the analog audio to acoustic waves.

The audio equipment 308 may comprise suitable logic, circuitry, and/or code that may enable it to be powered via an Ethernet cable 110 and also to extract audio from Ethernet frames and generate corresponding analog audio signals to be conveyed via the links 324. For example, the audio equipment may be an amplifier and/or cross-over. In various embodiments of the invention, the cables 324 may comprise conventional speaker wire or may comprise cabling typically found in Ethernet networks, such as Cat-5 cabling. In other embodiments of the invention, the audio equipment 308 may digitally process the audio and re-encapsulate the audio data into Ethernet frames prior for communication to the speakers 262.

The back-up assist camera 312 may comprise suitable logic, circuitry, interfaces, and/or code that that may enable it to be powered via an Ethernet cable 110 and also to capture images and convey those images to a display. In this regard, back-up assist camera 312 may encapsulate the captured image data into Ethernet frames and convey them, utilizing AVB, to the entertainment and/or navigation equipment 222 for viewing by the driver of the vehicle.

The microphone 320 may comprise suitable logic, circuitry, interfaces, and/or code that may enable it to be powered via an Ethernet cable 110 and also to convert acoustic waves into digital audio data. Audio from the microphone 320 may enable a user (driver or passenger) to control various functions of the vehicular electronics network 300 via voice commands. Additionally, the microphone 320 may enable interaction, via Bluetooth or Wi-Fi for example, with a cell phone or other portable electronic device via the vehicular electronics network 300.

The entertainment equipment 304 may be similar to or the same as the computing and/or entertainment equipment 228 described with respect to FIG. 2B. In various embodiments of the invention, the entertainment equipment 304 may encapsulate audio and/or video into Ethernet frames and communicate the frames utilizing AVB to various portions of the network 300. In this regard, the multimedia may, for example, be played back from an optical disc or digital storage medium. In some embodiments of the invention, entertainment equipment 304 may be a video game console. Control information may be communicated, possibly utilizing AVB, to the entertainment equipment 304 from one or more other devices of the network 300. In this regard, the entertainment equipment 304 may be controlled to, for example, select a desired disc, track, or file to be played back.

FIG. 3B is a diagram illustrating an exemplary vehicular electronics network, in accordance with an embodiment of the invention. Referring to FIG. 3B, the vehicle 352 may comprise a vehicular electronics network 350 similar to the vehicular electronics network 250 described with respect to FIG. 2C. In this regard, FIG. 3B may depict an exemplary vehicular electronics network 350 communicatively coupled in a star topology via Ethernet links 110 and nodes 254. Various other embodiments of the invention may comprise additional, different, and/or fewer electronic devices without deviating from the scope of the invention.

In various embodiments of the invention, one or more redundant network links, such as the cable 115 depicted as a dashed line in FIG. 3B, may be present in the vehicular electronics network. In various embodiments of the invention, loops in the network may be normally blocked as a result of a spanning tree algorithm but may be utilized in the event of a network failure. Alternatively, redundant paths may be utilized to increase throughput between two or more nodes in a network.

FIG. 3C is a diagram illustrating an exemplary vehicular electronics network, in accordance with an embodiment of the invention. Referring to FIG. 3C, the vehicle 372 may comprise a vehicular electronics network 370 similar to the vehicular electronics network 275 described with respect to FIG. 2D. In this regard, FIG. 3C may depict an exemplary vehicular electronics network 370 communicatively coupled in a daisy-chained topology via Ethernet cables 110. The vehicular electronics network 370 may comprise entertainment and/or navigation equipment 272, displays 274, speakers 226, computing device 374, back-up assist camera 376, entertainment equipment 378, and audio equipment 380. Various other embodiments of the invention may comprise additional, different, and/or fewer electronic devices without deviating from the scope of the invention.

The various devices of the network 370 may be similar to the corresponding devices of the network 350 but each device may comprise one or more additional network ports and associated circuitry, logic, and/or code. Accordingly, one or more of the devices of the network 370 may be operable to forward packets and route supply power between its two or more ports. In this manner, data exchanged between, for example, the entertainment and/or navigation equipment 272 and the displays 274 may be routed via the computing device 374. Similarly, supply power delivered from the entertainment and/or navigation equipment 272 may pass through the computing device 374 en route to the displays 274.

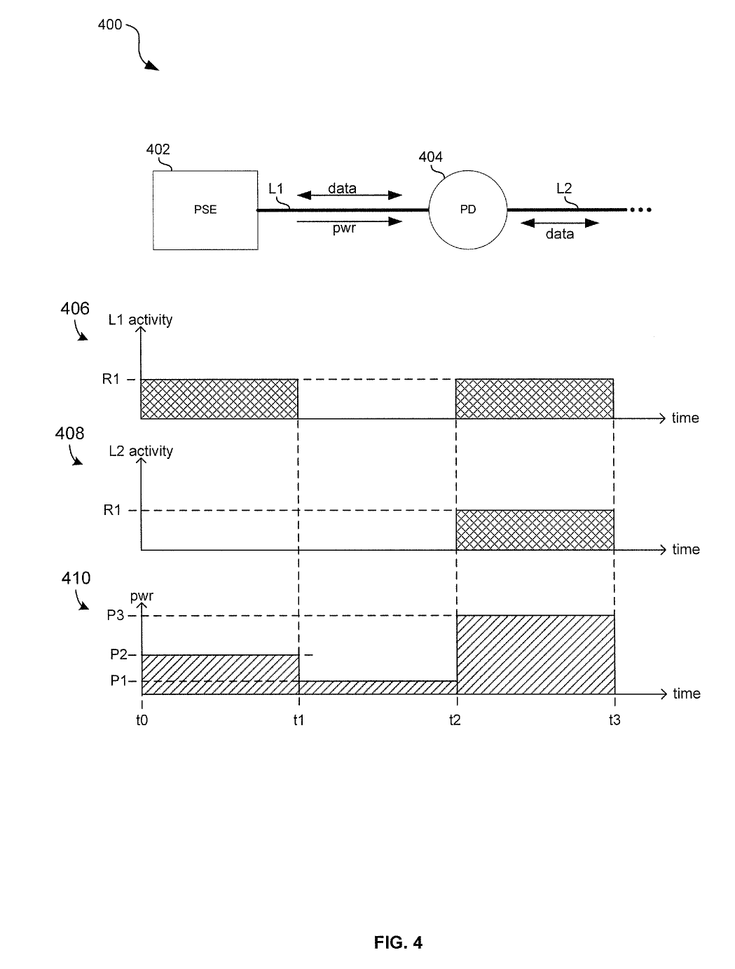

FIG. 4 is a diagram illustrating distribution of supply power in a vehicular electronics network, in accordance with an embodiment of the invention. Referring to FIG. 4 there is shown a PSE 402 and a PD 404 of a vehicular electronics network 400 and also graphs 406, 408, and 410 depicting an exemplary operation of the vehicular electronics network 400. The PSE 402 may be similar to or the same as the networking device 254 described with respect to FIGS. 2C and 3B. The PD 404 may be similar to or the same as, for example, the devices 320, 252, 224, 308, 304, 306, 308, and/or 312 described with respect to FIG. 3B. The PD 404 may communicate with the PSE 402 and with another electronic component (not shown) via the links L1 and L2, respectively.

During time interval t0 to t1, as depicted in graphs 406 and 408, the PD 404 may communicate data at a rate of R1 over the link L1 and the link L2 may be idle. Thus, the aggregate throughput of the PD 404 may be equal to R1. Accordingly, as depicted in the graph 410, an amount of supply power, P2, sufficient for the PD 404 to communicate at a rate of R1 may be provided to the PD 404 over the Ethernet link L1.

During time interval t1 to t2, both links L1 and L2 may be idle. Thus, the aggregate throughput of the PD 404 may be 0. Accordingly, only a minimal, or standby, amount of supply power, P1, may be provided to the PD 404 over the Ethernet link L1.

During time interval t2 to t3, as depicted in graphs 406 and 408, the PD 404 may communicate data at a rate of R1 over each of the links L1 and L2. Thus, the aggregate throughput of the PD 404 may be equal to 2*R1. Accordingly, an amount of supply power, P3, sufficient for the PD 404 to communicate at a rate of 2*R1 may be provided to the PD 404 over the Ethernet link L1.

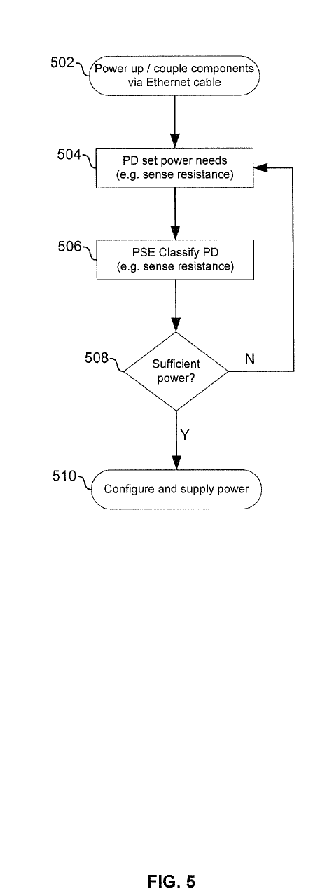

FIG. 5 is a flow chart illustrating powering one or more devices of a vehicular electronics network via one or more Ethernet cables, in accordance with an embodiment of the invention. Referring to FIG. 5, the exemplary steps may being with step 502 when two or more devices of a vehicular electronics network may be communicatively coupled via one or more Ethernet cables and powered up, wherein at least one of the devices operates as a PSE and at least one of the devices operates as a PD. Subsequent to step 502, the exemplary steps may advance to step 504. In step 504, the PD may determine its supply power requirements and set a power indicator, such as a sense resistance, accordingly. Subsequent to step 504, the exemplary steps may advance to step 506. In step 506, the PSE may detect a status and/or configuration of the PD's power indicator. Subsequent to step 506, the exemplary steps may advance to step 508. In step 508, it may be determined whether the PSE may be capable of meeting the supply power needs of the PD. In instances that the PSE may meet the demands of the PD, without sacrificing supply power needs of other more important devices (e.g., mission critical devices), for example, the exemplary steps may advance to step 510. In step 510, the PSE may be configured to supply to the amount of supply power requested by the PD via the PD's power indicator. Returning to step 508, in instances that the PSE may be unable to meet the supply power needs of the PD, the exemplary steps may return to step 504 and the PD may establish lower supply power requirements. In this regard, the PD may, for example, reduce the rate at which it may process data such that its supply power needs are reduced.

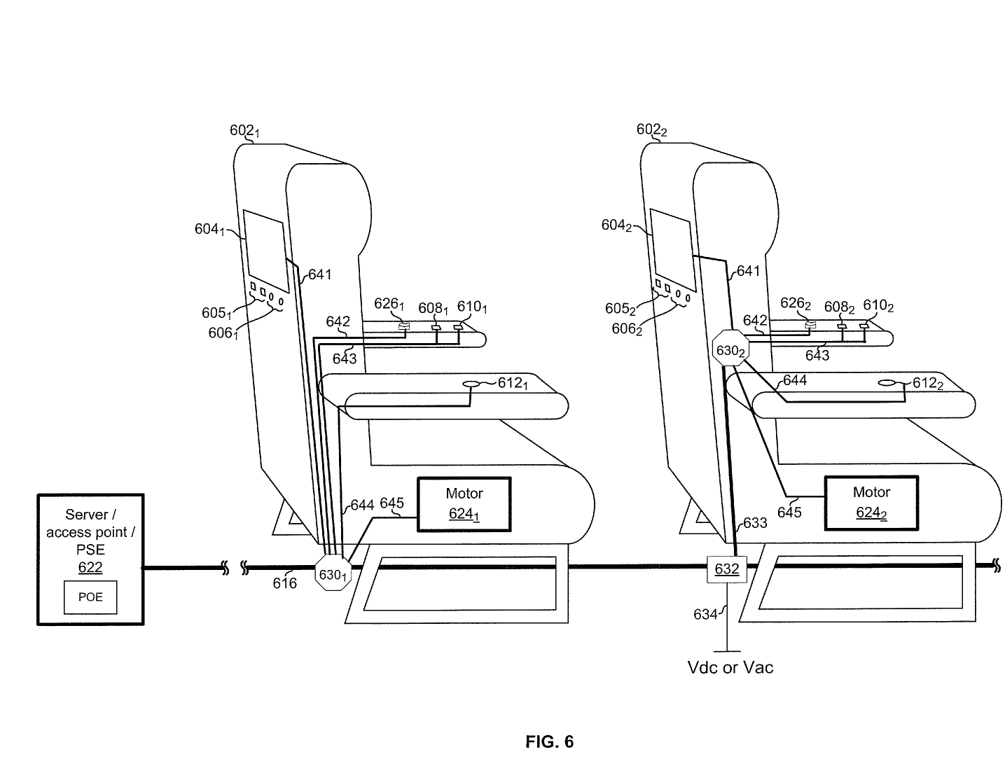

FIG. 6 is a diagram illustrating supply power distribution utilizing power over Ethernet (PoE) in an aircraft, in accordance with an embodiment of the invention. Referring to FIG. 6 there is shown a server and/or access point device 622 and passenger seats 602₁ and 602₂.

The server and/or access point 622 may be similar to, or the same as, one or more of the PSE 101 (FIG. 1) and the entertainment and/or navigation equipment 222 (FIG. 2B). In this regard, the server and/or access point 622 may be operable to provide supply power to, and communicate with, one or more clients via the network link 616, which may be similar to or the same as the cable 110 (FIG. 1). In this regard, the clients may comprise, for example, devices built into one or more of the seats 602 and/or electronic components utilized by flight attendants, electronic components integrated into overhead compartments, electronic components in common areas of the aircraft, and/or electronic components on the flight deck.

Although a single server and/or access point 622 is shown, a plurality of the servers and/or access points 622 may be installed in an aircraft. For example, a plurality of servers and/or access points 622 may be installed and each may serve and/or provide supply power to a particular section or sections of seats 602. Additionally or alternatively, the plurality of the servers and/or access points 622 may be redundant systems that may, for example, increase reliability in instances that the server 622 provides information and/or supply power to electronic components on the flight deck.

In various embodiments of the invention, the server and/or access point 622 may comprise, and/or be controlled via, a console or head-unit that is used by flight attendants to show content, such as safety videos and in-flight movies, to the passengers. In various embodiments of the invention, the server and/or access point 622 may provide supply power and/or data to instruments on the flight deck. In such instances, data and/or supply power provided to the flight deck may be given priority, e.g., utilizing AVB, over data and/or supply power being provided to passenger seats, for example. Similarly, mission critical information and/or supply power to mission-critical components may be given priority over non-mission-critical data and/or supply power to non-mission critical components.

Also, in various embodiments of the invention, one or more uninterruptible power supplies (UPSs) may be installed on the aircraft. The UPS may, for example, provide supply power via cables 616 and/or 633 to mission critical systems in the event of a failure of the server 622, failure of a device such as the device 632, and/or other failure of the aircraft power system. Similarly, power supplying equipment on the aircraft, such as the server 622 and the device 632, may be operable to provide supply power from multiple power sources on the aircraft. For example, a device 632 that provides supply power to mission critical systems may be powered by a primary aircraft power system as well as a backup and/or emergency power system such as a generator.

In various embodiments of the invention, the server and/or access point 622 may serve media, gaming, Internet, and/or other information and/or content. In various embodiments of the invention, the server and/or access point 622 may be powered via a power system of the aircraft and may regulate and/or otherwise condition the supply power for distribution to other electronic components via the link 616.

In various embodiments of the invention, the server and/or access point 622 may be operable to provide cellular and/or voice over IP (VoIP) calling services. For example, the server and/or access point 622 may function as a femtocell. Additionally or alternatively, the server and/or access point 622 may provide wireless networking, e.g. IEEE 802.11 wireless networking, and may enable passengers to make VoIP calls from their computer and/or VoIP-enabled handsets.

The seats 602₁ and 602₂ may each comprise various electronic components. Exemplary components may comprise a display 604 and associated controls 605 and inputs 606, an Ethernet port 608, a DC power port 610, a headphone jack 612, and a motor 624 and associated controls 626. One or more of the electronic components may comprise a powered device such as the PD 103 described with respect to FIG. 1.

The display 604 may be similar to, or the same as, the display 304 (FIG. 3). The inputs 606 may comprise, for example, analog and/or digital audio inputs and/or outputs, analog and/or digital video inputs and/or outputs, and/or general input and/or output ports such as USB or IEEE 1394. The Ethernet port 608 may be an 8P8C connector which a passenger may connect his laptop to access a local area network of the aircraft and/or to access the Internet, for example. The Ethernet port 608 may also be enabled to provide supply power to devices connected to it utilizing supply power delivered over the link 616 and/or a link 633. The controls 605 may comprise a volume control buttons, channel select buttons, gaming controls, keyboard, a touchscreen, and/or other input devices.

The DC power port 610 may provide supply power to enable a passenger to power or charge portable electronics, for example. The DC power port 610 may comprise, for example, a powered USB port and/or a DC outlet such as may be found in a car. In various embodiments, various adaptors, power converters, and/or power inverters may be utilized to adapt the form factor and/or pin-out of the DC power port 610 and/or to adapt the voltage and/or current out of the DC power port 610. In this manner, the DC power port 610 may be compatible with a variety of electronic devices. In various embodiments of the invention, the adaptor(s), converter(s), and/or inverter(s) may be integrated into one or more of the seats 602. In an exemplary embodiment of the invention, the DC power port 604 may be powered via supply power delivered over the link 616 and/or 633. In an exemplary embodiment of the invention, the DC power port 604 may be powered via supply power delivered over the link 633 injected by the device 632.

Each motor 624 may comprise suitable logic, circuitry, interfaces, and/or code that may be operable to control a position, e.g. angle of recline and/or of a footrest, of the seat 624. Controls for controlling the position of the seat 624 may be, for example, integrated in an armrest such as controls 626 and/or may be controlled via the display 604 and controls 605. In an exemplary embodiment of the invention, the DC power port 604 may be powered via supply power delivered over the link 616 and/or 633. In an exemplary embodiment of the invention, the DC power port 604 may be powered via supply power delivered over the link 633 injected by the device 632.

Electronic components, such as those integrated in a seat 602, may be coupled to a power and/or communications system of the aircraft via a device 630. Each of the devices 630₁ and 630₂ may comprise suitable logic, circuitry, interfaces, and/or code that may be operable to interface with one or more network links and interface with one or more electronic components. Accordingly, each device 630 may be operable to perform computing and/or networking functions. In this regard, each device 630 may function as a gateway between the Ethernet link 616 and the components integrated into a seat 602. In this regard, each device 630 may perform functions of a set-top-box, a motherboard, and/or a network device such as an Ethernet bridge or switch. In this regard, each device 630 may be operable to receive packets via a port connected to the link 616, extract media and/or signals from the received packets, and convey the extracted media and/or signals, via cabling and/or wiring 641-645, to the components of the seat 602. For example, each device 630 may receive a multimedia stream received via the link 616, and may convey the video information of the stream to the display 604 and corresponding audio to the headphone jack 612. In various embodiments of the invention, the video may be communicated to the display as packetized video or as raw video. As another example, a command to return the seats 624 to an upright position may be received over the link 616 and each device 630 may output corresponding signals to the motor 624.

Similarly, each device 630 may receive media and/or signals from electronic components, such as those integrated in a corresponding seat 602, packetize the media and/or signals, and communicate the packets to the server and/or access point 622. For example, each device 630 may generate requests or other control packets based on signals from the controls 605, and communicate the control and/or request packets to the server and/or access point 622. As another example, server and/or access point 622 may have a wireless connection to the Internet and internet data may be communicated between the server and/or access point 622 and the Ethernet port 608.

Additionally, in various embodiments of the invention, each device 630 may be operable to receive supply power via a link 616 and/or 633 and may be operable to regulate and/or otherwise condition the supply power and may be operable to distribute the supply power among the electronic components integrated into a seat 602.

In various embodiments of the invention, electronic components integrated within and/or on seats 602 may connect to the link 616 via one or more devices 632 which may comprise, for example, a bridge, a hub, and/or a switch. A device 632 may, for example, be mounted to the aircraft for each section of one or more seats 602. In various embodiments of the invention the device 632 may operate as a PSE and may be an endspan and/or a midspan. In this regard, the device 132 may be operable to connect, via cable 634, to an AC and/or DC power system of the airplane and regulate and/or otherwise condition the power for delivery to one or more seats 602.

In various embodiments of the invention, power supplying equipment such as the server 622 and the device 632 may provide power via a cable 616 or 633 to a wireless access point such as a IEEE 802.11 router and/or a cellular hub such as a femtocell. In this regard, the use of wireless networks may enable reducing wiring cost, complexity, and weight.

In various embodiments of the invention, supply power may be received via one or more motors 624. In this regard, a motor 624 may be connected to aircraft power via a cable, such as the cable 634, and may use the aircraft power to generate a separate supply power. For example, the motor 624 may comprise a power converter, inverter, and/or regulator to generate other supply voltages, such as 120V at 60 Hz or 50 Hz, from aircraft power that is formatted in accordance with one or more aviation standards. In this regard, aviation standards often specify that aircraft power systems should be 115V at 400 Hz, 28Vdc, or 26Vdc. In this regard, various AC and/or DC power outputs may be provided from a motor 624 to various other electronic components in the aircraft, such as the electronic components integrated in a seat 602. Additionally or alternatively, power may be output from a motor 624 to a device 632.

In various embodiments of the invention, supply power may be tapped into at one or more powered components of the aircraft such as the motor 624, overhead lighting, and/or overhead fans. In this regard, rather than having to run power over a long stretch of cable, a device 632 may tap into a power line that goes to various pre-existing components in the aircraft, such as overhead lights.

The seat 602₁ illustrates an exemplary embodiment of the invention in which a device 630 is built into or mounted to the aircraft. The device 630 may interface to, for example, a row of seats 624. In such an instance, the seats 602 may be connected to the device 630 in a star topology. The seat 602₂ illustrates an exemplary embodiment of the invention in which the device 630 is built into or mounted to the seat 602₂ and connects to the device 632. Seat 602₂ may be connected to a device 632 via the link 633 and additional seats 602 may be daisy chained to the seat 602₂. In this regard, the device 630 may comprise multiple Ethernet ports for daisy chaining the seats 602.

In various embodiments of the invention, the server and/or access point 622, the network devices 630, and/or the network device 632 may be operable to perform diagnostic testing of the link 616, the link 633, and/or one or more of the cables and/or wires 641-645. Furthermore, results of such tests may be communicated to and/or stored on the server and/or access point 622 such that they may read out during aircraft maintenance.

Although FIG. 2B depicts the server 622 providing data to electronic components integrated within passenger seats, the invention is not so limited. For example, various components such as the displays 604, the controls 605, the inputs 606, the Ethernet port 608, the DC power port 610, the headphone jack 612, and the controls 626 may be integrated into overhead compartments and/or in common areas of the aircraft.

Various aspects of a method and system for vehicular power distribution utilizing power over Ethernet in an aircraft are provided. In an exemplary embodiment of the invention, one or more circuits and/or processors, such as a device 630, may be operable to receive supply power that is formatted in accordance with one or more aviation standards (e.g., 115Vac at 400 Hz, 28Vdc, or 26Vdc), condition the received supply power (e.g., filter it, regulate it, and/or convert it to another voltage and/or frequency), and provide the conditioned supply power to one or more electronic components that are communicatively coupled to the Ethernet cable. The electronic components may comprise one or more of: a display 604, an Ethernet port 608, an audio input port 606, an audio output port 612, a video input port 606, a video output port 606 a power port 610, an input device 605, and a motor 624. The device 630 may be operable to perform bridging, switching, and/or routing functions. One or more of the electronic components and/or the device 630 may be built into and/or mounted on the one or more seats in the aircraft. The conditioned supply power may be delivered in adherence with power over Ethernet standards. The device 630 may provide the conditioned supply power to the one or more electronic components based on a power classification of the one or more electronic components. The power classification may be determined utilizing layer 2 and/or 2-event classification The device 630 may comprise a plurality of Ethernet ports such that seats 602 in the aircraft may be connected in a daisy-chain configuration or topology. The device 630 may be operable to extract media from Ethernet packets received over the Ethernet cable 616 and/or 633 and convey the media to one or more of the electronic components. The device 630 may be operable to format the media prior to conveyance to the one or more of the electronic components. The Ethernet cable 616 and/or 633 may comprise one or more twisted pairs. The conditioning may comprise one or more of: adjusting a frequency of the received supply power, adjusting voltage levels of the received supply power, alternating current to direct current (AC to DC) conversion, and direct current to alternating current (DC to AC) conversion.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for vehicular power distribution utilizing power over Ethernet in an aircraft.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for networking, the method comprising:
performing in an aircraft:
receiving supply power that is formatted in accordance with one or more aviation standards;
conditioning said received supply power;
providing said conditioned supply power to said one or more electronic components via an Ethernet cable that also carries data, wherein said supply power powers one or more electronic components that are installed in said aircraft and coupled to said Ethernet cable.

2. The method according to claim 1, wherein said electronic components comprise one or more of a display, an Ethernet port, an audio input port, an audio output port, a video input port, a video output port, a power port, an input device, and a motor.

3. The method according to claim 1, comprising bridging, switching, and/or routing said data.

4. The method according to claim 1, wherein said one or more electronic components are built into and/or mounted on one or more seats of said aircraft.

5. The method according to claim 1, wherein said conditioned supply power is provided to said electronic components in adherence with power over Ethernet standards.

6. The method according to claim 1, comprising providing said conditioned supply power to said one or more electronic components based on a power classification of said one or more electronic components.

7. The method according to claim 6, wherein said power classification is determined utilizing layer 2 and/or 2-event classification.

8. The method according to claim 1, comprising extracting media from Ethernet packets received over said Ethernet cable and conveying said media to one or more of said electronic components.

9. The method according to claim 8, comprising formatting said media prior to said conveyance to said one or more of said electronic components.

10. The method according to claim 1, wherein said conditioned supply power delivered to said electronic components has the same voltage levels as said received supply power.

11. The method according to claim 1, wherein said conditioned supply power delivered to said electronic components has the frequency as said received supply power.

12. The method according to claim 1, wherein said conditioning comprises one or more of: adjusting a frequency of said received supply power, adjusting voltage levels of said received supply power, alternating current to direct current (AC to DC) conversion, and direct current to alternating current (DC to AC) conversion.

13. A system for networking, the system comprising:
one or more circuits and/or processors in an aircraft, said one or more circuits being operable to:
receive supply power that is formatted in accordance with one or more aviation standards;
condition said received supply power;
provide said conditioned supply power to said one or more electronic components via an Ethernet cable that also carries data, wherein said supply power powers one or more electronic components that are installed in said aircraft and coupled to said Ethernet cable.

14. The system according to claim 13, wherein said electronic components comprise one or more of a display, an Ethernet port, an audio input port, an audio output port, a video input port, a video output port, a power port, an input device, and a motor.

15. The system according to claim 13, wherein said one or more circuits and/or processors are operable to perform bridging, switching, and/or routing functions.

16. The system according to claim 13, wherein:
one or more of:
said one or more circuits and/or processors, and
said one or more electronic components are built into and/or mounted on one or more seats of said aircraft.

17. The system according to claim 13, wherein said conditioned supply power is provided to said electronic components in adherence with power over Ethernet standards.

18. The system according to claim 13, wherein said one or more circuits and/or processors provide said conditioned supply power to said one or more electronic components based on a power classification of said one or more electronic components.

19. The system according to claim 18, wherein said power classification is determined utilizing layer 2 and/or 2-event classification.

20. The system according to claim 13, wherein said one or more circuits and/or processors are operable to extract media from Ethernet packets received over said Ethernet cable and convey said media to one or more of said electronic components.

21. The system according to claim 20, wherein said one or more circuits and/or processors are operable to format said media prior to said conveyance to said one or more of said electronic components.

22. The system according to claim 13, wherein said conditioned supply power delivered to said electronic components has the same voltage levels as said received supply power.

23. The system according to claim 13, wherein said conditioned supply power delivered to said electronic components has the frequency as said received supply power.

24. The system according to claim 13, wherein said conditioning comprises one or more of: adjusting a frequency of said received supply power, adjusting voltage levels of said received supply power, alternating current to direct current (AC to DC) conversion, and direct current to alternating current (DC to AC) conversion.
